(19) United States
(12) Patent Application Publication
(10) Pub. No.: US 2025/0150849 A1
(43) Pub. Date: May 8, 2025

(54) SYSTEMS AND METHODS FOR DYNAMIC NETWORK SLICING

(71) Applicant: Verizon Patent and Licensing Inc., Basking Ridge, NJ (US)

(72) Inventors: Vijayakrishna P. Guduru, Denville, NJ (US); Sudhakar Reddy Patil, Flower Mound, TX (US); Raquel Morera Sempere, Weehawken, NJ (US); David Taft, Keller, TX (US)

(21) Appl. No.: 18/504,675

(22) Filed: Nov. 8, 2023

(51) Int. Cl. H04W 24/02

(52) U.S. Cl. CPC H04W 24/02

(57) ABSTRACT

Systems and methods described herein provide dynamic network slicing. A network device receives, from an application server, application performance requirements for an application and receives capability and performance information of an existing network slice that is servicing a User Equipment (UE) device using the application. The network device determines, based on the capability and performance information, that a new network slice is needed to support the application performance requirements for the UE device; and sends a signal to initiate a slice creation process for the new network slice.

### BACKGROUND

Fifth Generation (5G) networks offer many new technological features unavailable in predecessor networks. For example, through use of network slicing, 5G networks may provide application and subscriber-specific Quality of Service (QOS) provisioning for variety of applications. Other benefits of network slicing may include improved network resource utilization, faster rollout times for new services without significant modifications to the existing network infrastructure, and increased security. Depending on a number of use cases, there is a high demand to differentiate service, connection, and mobility handling on network slices.

### BRIEF DESCRIPTION OF THE DRAWINGS

FIG. 1 is a diagram that depicts an exemplary network environment in which systems and methods described herein may be implemented;

FIG. 2 is a diagram illustrating a network portion that includes exemplary components of a core network, according to an implementation described herein;

FIG. 3 is a diagram illustrating network slicing in a multi operator core network (MOCN) environment, according to an implementation described herein;

FIG. 4 illustrates example components of a device, according to an implementation described herein;

FIG. 5 is a signal flow diagram illustrating communications to provide dynamic slice creation, according to an implementation described herein; and

FIGS. 6-8 are flow diagrams illustrating example processes for providing dynamic slice creation, according to implementations described herein.

### DETAILED DESCRIPTION

The following detailed description refers to the accompanying drawings. The same reference numbers in different drawings may identify the same or similar elements.

A network slice is a logical network that provides specific network capabilities and characteristics. Under current standards, an end-to-end system may be capable of supporting up to eight network slices. When mobile network operators (MNOs) deploy multiple network slices for private and public networks, it may be desirable to dynamically create different slices based on certain intelligence and network conditions. Current mobile networks are not designed to address such scenarios.

Systems and methods described herein provide an end-to-end architecture, network functions, signaling flows, and other mechanisms necessary to enable dynamic slicing. The systems and methods leverage existing standards in new ways, augmenting them as needed.

For example, the systems and methods may augment a new slice with different slice characteristics to meet certain requirements for an application or customer. To effectively provide such a service, a system needs to know at least two categories of information: (a) the performance requirements for an application being served, and (b) the network capability and actual performance of the network slices. Information from either of these categories may change dynamically. In implementations described herein, an artificial intelligence (AI) engine may collect and apply information from both categories to identify a need for a new slice. Once the need is identified to create a new slice with different characteristics, infusion of the new slice may be accomplished via, for example, (1) an over the top application on the User Equipment (UE) device or (2) a network triggered slice orchestration.

According to an implementation, a network device (e.g., an AI engine located at a network edge or in another network) may receive application performance requirements from an external application server and may receive, from a multi-access edge computing (MEC) device, capability and performance information of an existing network slice that is servicing the external application server. The network device may determine, based on the capability and performance information, that a new network slice is needed to support the application performance requirements for a UE device. The network device may send, to the MEC device, a signal to initiate a slice creation process for the new network slice.

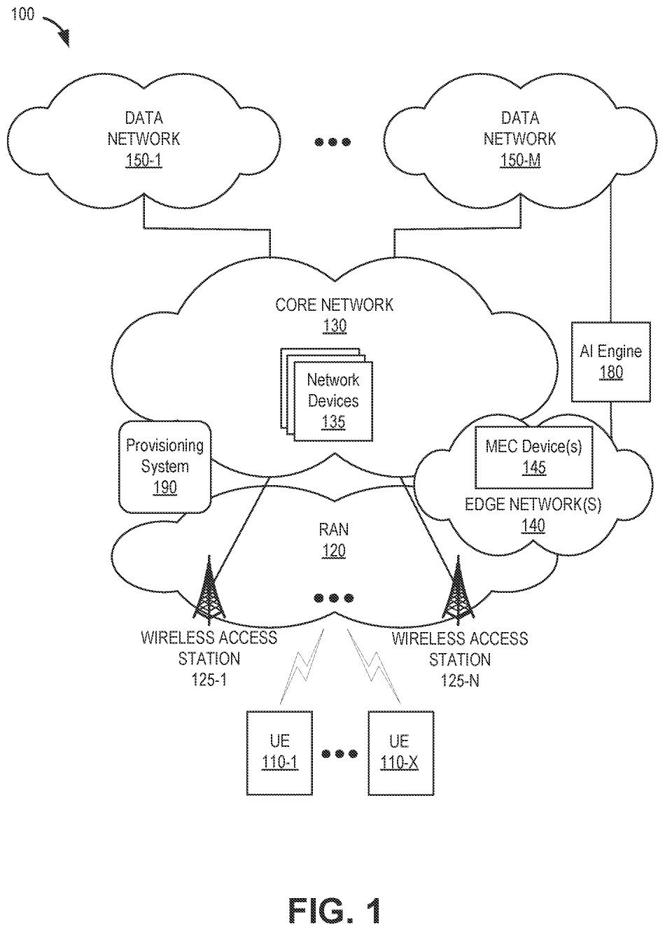

FIG. 1 is a diagram of an example environment 100 in which the systems and/or methods, described herein, may be implemented. As shown in FIG. 1, environment 100 may include user equipment (UE) devices 110-1 to 110-X (referred to herein collectively as “UE devices 110” and individually as “UE device 110”), a radio access network (RAN) 120, a core network 130, one or more edge networks 140, data networks 150-1 to 150-M, an AI engine 180, and a provisioning system 190.

UE device 110 may include any device with long-range (e.g., cellular or mobile wireless network) wireless communication functionality. For example, UE device 110 may include a handheld wireless communication device (e.g., a mobile phone, a smart phone, a tablet device, etc.); a telematics system in a vehicle; a wearable computer device (e.g., a head-mounted display computer device, a wristwatch computer device, etc.); a laptop computer, a tablet computer, or another type of portable computer; a desktop computer; a customer premises equipment (CPE) device, such as a set-top box or a digital media player, a WiFi access point, a fixed wireless access (FWA) device, a smart television, etc.; a portable gaming system; an automated guided vehicle (AGV); global positioning system (GPS) device; a home appliance device; a home monitoring device; and/or any other type of computer device with wireless communication capabilities. UE device 110 may include capabilities for voice communication, mobile broadband services (e.g., video streaming, real-time gaming, premium Internet access etc.), best effort data traffic delivery, and/or other types of capabilities. In some implementations, UE device 110 may communicate using machine-to-machine (M2M) communication, such as machine-type communication (MTC), and/or another type of M2M communication. In still other implementations, UE device 110 may include a Redcap (reduced capability) device that is used for applications such as industrial wireless sensors.

RAN 120 may enable UE devices 110 to connect to core network 130 and/or edge network 140 via wireless access stations 125-1 through 125-N (referred to herein collectively as “access stations 125” and individually as “access station 125”) using cellular wireless signals. Each access station 125 may service a set of UE devices 110. For example, access station 125-1 may service some UE devices 110 when the UE devices 110 are located within the geographic area serviced by wireless access station 125-1, while other UE devices 110 may be serviced by another wireless access station 125 when the UE devices 110 are located within the geographic area serviced by the other wireless access station 125.

Access station 125 may include a 5G New Radio (NR) base station (e.g., a gNodeB) and/or a Fourth Generation (4G) Long Term Evolution (LTE) base station (e.g., an eNodeB). According to an implementation, a wireless access station 125 may include a gNodeB or its equivalent with multiple distributed components, such as a central unit (CU), a distributed unit (DU), a remote unit (RU or a remote radio unit (RRU)), or another type of component to support distributed arrangements. Each access station 125 may include devices and/or components configured to enable cellular wireless communication with UE device 110. For example, access station 125 may include a radio frequency (RF) transceiver configured to communicate with UE devices 110 using a 5G NR air interface, a 4G LTE air interface, and/or using another type of cellular air interface. Access station 125 may enable communications with core network 130 to enable core network 130 to authenticate and monitor network activity of UE device 110. According to one implementation, RAN 120 may include a non-standalone (NSA) network to support dual coverage using 4G and 5G networks. In another implementation, RAN 120 may include a 5G standalone (SA) architecture.

Core network 130 may manage communication sessions for UE devices 110. For example, core network 130 may be implemented to include a next generation core (NGC) network for a 5G network, an Evolved Packet Core (EPC) of an LTE network, an LTE-A network, an LTE-A Pro network, another type of 4G core network, and/or a legacy core network. Core network 130 may provide mobility management, session management, authentication, and packet transport, to support wireless communication services for UE devices 110. Core network 130 may further provide access to data networks 150. For example, core network 130 may establish an Internet Protocol (IP) connection between UE device 110 and a particular data network 150. Core network 130 may include various types of network devices 135, which may implement different network functions described further herein.

Each edge network 140 may be associated with one or more access stations 125 and may provide edge services for UE devices 110 attached to the access station 125. At least a portion of edge network 140 (e.g., a MEC platform) may be in proximity to the access station 125 from a geographic and network topology perspective, thus enabling low latency communication with UE device 110 and/or access station 125. As an example, edge network 140 may be located on a same site as one of the access stations 125. As another example, edge network 140 may be geographically closer to a access station 125 and reachable via fewer network hops and/or fewer switches than other access stations 125 and/or data networks 150. Edge network 140 may include MEC devices 145 that may be configured to provide various services and/or functions. MEC devices 145 may provide services to UE device 110, such as, for example, application services and dynamic network slicing services.

Data networks 150 may each include a data network, such as a packet data network. A particular data network 150 may be associated with an Access Point Name (APN), and UE device 110 may request a connection to the particular data network 150 using the APN. Data network 150 may include, and/or be connected to and enable communication with, a local area network (LAN), a wide area network (WAN), a metropolitan area network (MAN), an autonomous system (AS) on the Internet, an optical network, a cable television network, a satellite network, a wireless network (e.g., a 5G system and/or an LTE network), an ad hoc network, a telephone network (e.g., the Public Switched Telephone Network (PSTN) or a cellular network), an intranet, or a combination of networks. In some implementations, one or more network functions of data network 150 may be deployed locally (e.g., in edge network 140). Data network 150 may include an application server (also referred to as application). An application may provide services for a program or an application running on UE device 110 and may establish communication sessions with UE device 110 via core network 130.

AI engine 180 may include a network device and/or network function that receives application performance requirements from an external application server (e.g., a device in data network 150), receives network capability and performance information from a network (e.g., core network 130), and determines whether a new network slice is needed to support the application performance requirements. According to some exemplary embodiments, AI engine 180 may include AI and/or machine learning (ML) logic that may analyze and predict operational characteristics, such as performance metrics, key performance indicators (KPIs), and so forth. AI engine 180 may interface and coordinate with MEC devices 145 and components of data network 150, among other components, as described further herein. AI engine 180 may be configured to learn user traffic patterns and push an optimized policy to MEC devices 145. According to different implementations, AI engine 180 may be co-located with a MEC device 145 or be a standalone device in a separate network.

Provisioning system 190 may include a network provisioning system, a network management system, a self-optimizing network (SON) system, etc. Provisioning system 190 may manage the physical components of RAN 120, core network 130, and/or MEC network 140. According to an implementation, provisioning system 190 may receive a service profile for a new network slice and create, based on the service profile, the new network slice that is configured to support the service profile.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

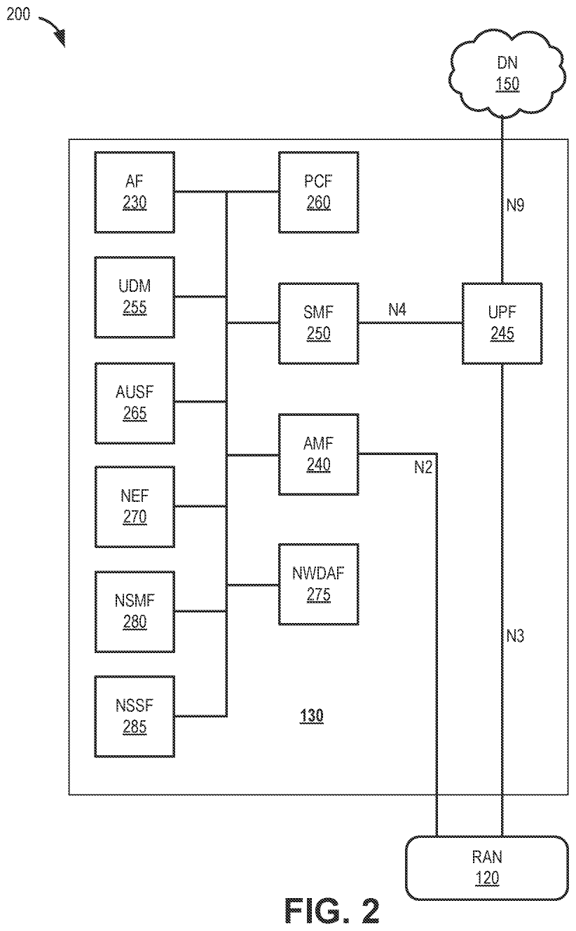

FIG. 2 is a diagram illustrating a network portion 200 that includes exemplary components of core network 130 in environment 100, according to an implementation described herein. As shown in FIG. 2, network portion 200 may include a RAN 120, data network 150, and various components of core network 130 described below. While FIG. 2 depicts a single instance of the network functions in network portion 200 for illustration purposes, in practice, there may be multiple instances of one or more network functions.

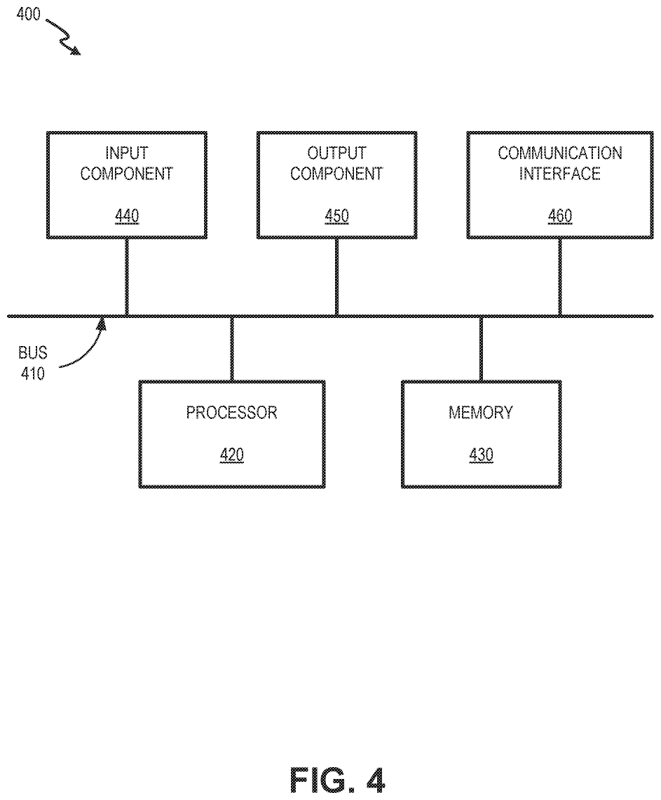

The components depicted in FIG. 2 may be implemented as dedicated hardware components (e.g., network devices 135) or as virtualized functions implemented on top of a common shared physical infrastructure using software defined networking (SDN). For example, an SDN controller may implement one or more of the components of FIG. 2 using an adapter implementing a virtual machine, a containerized network function (CNF) container, an event driven serverless architecture interface, and/or another type of SDN architecture. The common shared physical infrastructure may be implemented using one or more devices 400 described below with reference to FIG. 4 in a cloud computing center associated with core network 130.

As shown in FIG. 2, components of core network 130 may include an application function (AF) 230, an Access and Mobility management Function (AMF) 240, a User Plane Function (UPF) 245, a Session Management Function (SMF) 250, a Unified Data Management (UDM) and/or a Unified Data Repository (UDR) (referred to herein as UDM/UDR 255), a Policy Control Function (PCF) 260, an Authentication Server Function (AUSF) 265, a Network Exposure Function (NEF) 270, a Network Data Analytics Function (NWDAF) 275, a Network Slice Management Function (NSMF) 280, and a Network Slice Selection Function (NSSF) 285. In some implementations, an Application Function (AF) 230 may also be considered part of core network 130. Each of AF 230, AMF 240, UPF 245, SMF 250, UDM/UDR 255, PCF 260, AUSF 265, NEF 270, NWDAF 275, NSMF 280, and NSSF 285 may correspond to one or more network device 135.

AF 230 may provide services associated with a particular application, such as, for example, accessing NEF 270, interacting with a policy framework for policy control, application influence on traffic routing, and/or other types of applications. AF 230 may request network services. In instances where AF 230 is outside of core network 130 and/or is not a trusted device, NEF 270 may expose to AF 230 the mobile network's capability to support the certain network services.

AMF 240 may perform registration management, connection management, reachability management, mobility management, lawful intercepts, Short Message Service (SMS) transport, session management message transport between UE device 110 and SMF 250, access authentication and authorization, location services management, functionality to support non-3GPP access networks, and/or other types of management processes.

UPF 245 may maintain an anchor point for intra/inter-RAT mobility, maintain an external Packet Data Unit (PDU) point of interconnect to a particular data network 150, perform packet routing and forwarding, perform the user plane part of policy rule enforcement, perform packet inspection, perform lawful intercept, perform traffic usage reporting, perform quality of service (QOS) handling in the user plane, perform uplink traffic verification, perform transport level packet marking, perform downlink packet buffering, forward an “end marker” to a RAN 120 node (e.g., access station 125), and/or perform other types of user plane processes.

SMF 250 may perform session establishment, session modification, and/or session release, perform IP address allocation and management, perform Dynamic Host Configuration Protocol (DHCP) functions, perform selection and control of UPF 245, configure traffic steering at UPF 245 to guide the traffic to the correct destinations, terminate interfaces toward PCF 260, perform lawful intercepts, charge data collection, support charging interfaces, control and coordinate charging data collection, perform downlink data notification, manage roaming functionality, and/or perform other types of control plane processes for managing user plane data.

UDM/UDR 255 may maintain subscription information for UE devices 110, manage subscriptions, generate authentication credentials, handle user identification, perform access authorization based on subscription data, perform network function (NF) registration management, maintain service and/or session continuity by maintaining assignment of SMF 250 for ongoing sessions, support SMS message delivery, support lawful intercept functionality, and/or perform other processes associated with managing user data.

PCF 260 may support policies to control network behavior, provide policy rules to control plane functions (e.g., to SMF 250), access subscription information relevant to policy decisions, perform policy decisions, and/or perform other types of processes associated with policy enforcement.

AUSF 265 may perform authentication. For example, AUSF 265 may implement an Extensible Authentication Protocol (EAP) authentication server and may store authentication keys for UE devices 110.

NEF 270 may expose capabilities and events to other NFs, including third party NFs, AFs, edge computing NFs, and/or other types of NFs. Furthermore, NEF 270 may secure provisioning of information from external applications to core network 130, translate information between core network 130 and devices/networks external to core network 130, support a Packet Flow Description (PFD) function, and/or perform other types of network exposure functions, including exposing slice capacity and/or performance data, as described above.

NWDAF 275 may provide functions and/or services specified by a standards entity (e.g., 3GPP, etc.) and/or of a proprietary nature. NWDAF 275 may collect analytics information associated with RAN 120 and/or core network 130. For example, NWDAF 275 may collect accessibility KPIs (e.g., a Radio Resource Control (RRC) setup success rate, etc.), retainability KPIs (e.g., a call drop rate, etc.), mobility KPIs (e.g., a handover success rate, etc.), service integrity KPIs (e.g., downlink average throughput, downlink maximum throughput, uplink average throughput, uplink maximum throughput, etc.), utilization KPIs (e.g., resource block utilization rate, average processor load, etc.), availability KPIs (e.g., radio network unavailability rate, etc.), and/or other types of transport network KPIs. In one implementation, slice performance data from NWDAF 275 may be exposed (via NEF 270) to MEC device 145 for eventual use by AI engine 180.

NSMF 280 may manage network slices. The management may include instantiation, removal, and/or modification of network slices based on specifications and/or service profiles. If NSMF 280 creates a network slice, NSMF 280 may obtain a S-NSSAI for the network slice and store the S-NSSAI at NSSF 285. NSSF 285 may select a set of network slice instances to serve a particular UE device 110, determine NSSAI, determine a particular AMF 240 to serve a particular UE device 110, and/or perform other types of processes associated with network slice selection or management.

Although FIG. 2 shows certain components of network portion 200, in other implementations, network portion 200 may include fewer components, different components, differently arranged components, or additional components than depicted in FIG. 2. For example, although not illustrated in FIG. 2, core network 130 may include other network functions, such as a Charging Enablement Function (CEF), a Network Repository Function (NRF), etc. Additionally, or alternatively, one or more components of network portion 200 may perform functions described as being performed by one or more other components of network portion 200. Furthermore, while particular interfaces (e.g., N2, N3, N4, N9, etc.) are illustrated with respect to particular function nodes in FIG. 2, some network functions may include a reference point architecture that includes point-to-point interfaces between particular function nodes.

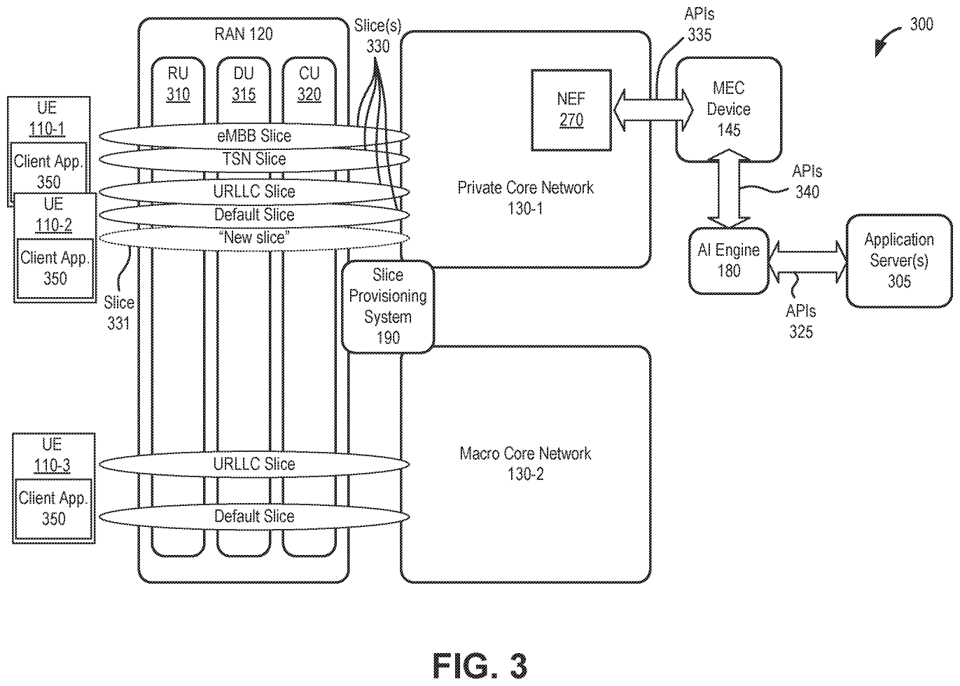

FIG. 3 is a diagram illustrating network slicing in a multi-operator core network (MOCN) environment 300, according to an implementation. MOCN environment 300 may be part of network environment 100. Network environment 300 may include UE devices 110-1 through 110-3, RAN 120, a private core network 130-1 and a macro core network 130-2 (referred to collectively as core networks 130), MEC devices 145-1 and 145-2, AI engine 180, and application server(s) 305.

Application server 305 (also referred to as an application function, or simply an application) may provide services for a program or a client application 350 running on UE device 110 and may establish communication sessions with UE device 110 via one of core networks 130. Application server 305 may generally be considered outside of (e.g., not part of) either of core networks 130. For example, application function 305 may be included within data network 150 or outside of data network 150 (as shown in FIG. 3). According to implementations described herein, application server 305 may use application programming interfaces (APIs) 325 to communicate service requirements or performance requirements to AI engine 180. For example, application server 305 may identify a service profile for an application that may include a latency value, a throughput value, a reliability value, a packet error rate, a bit rate (e.g., maximum bit rate (MBR), minimum bit rate, guaranteed bit rate (GBR)),a maximum data burst volume (MDBV), a jitter value, and/or similar types of information (e.g., key performance indicators (e.g., KPIs), a 5G QOS Identifier (5QI), a QoS Class Identifier (QCI), service level agreement (SLA) values, etc.).

RAN 120 may include an RU segment 310, a DU segment 315, and a CU segment 320 to support different network slicing options in conjunction with one or more of private core network 130-1 or macro core network 130-2.

Private core network 130-1 includes one or multiple networks of one or multiple types serviced by a private or government enterprise other than an MNO (e.g., for employees, customers, selected users, etc.). According to an implementation, private core network 130-1 may include a complementary network pertaining to private RAN 120. For example, private core network 130-1 may include a core part of a private next generation wireless network. Private core network 130-1 may include an NEF 270 and various types of other network devices (not shown), such as, for example, any of network devices 135 described above in connection with FIG. 2.

Macro core network 130-2 may include an MNO network for subscribers. Macro core network 130-2 may include components similar to those described above in connection with private core network 130-1.

RAN 120, private core network 130-1, and/or macro core network 130-2 may support a variety of network slices 330 that may provide different service levels to subscribers (e.g., users of UE devices 110). Network slices 330 may be capable of supporting enhanced Mobile Broadband (eMBB) traffic, Ultra Reliable Low Latency Communication (URLLC) traffic, Time Sensitive Network (TSN) traffic, Massive Internet of Things (MIoT) traffic, Vehicle-to-Everything (V2X) traffic, High performance Machine Type Communication (HMTC) traffic, and other customized traffic, for example. According to implementations described herein, a new slice 331 may be added to network environment 300 to support a specific service profile for an application.

MEC devices 145 may interface with one of private core network 130-1 or macro core network 130-2 to obtain slice performance information from a corresponding core network. For example, a NEF 270 in a core network 130 may expose to MEC devices 145, via APIs 335, slice 330 performance data, such as a 5QI, a Packet Error Rate (PER), a latency value, subscriber profile identifier (SPID)/radio access technology (RAT) frequency selection priority (RFSP), public land mobile network (PLMN), and/or an Allocation and Retention Policy (ARP). MEC devices 145 may, in turn, expose the slice performance data to AI engine 180 via APIs 340. Additionally, upon a signal from AI engine 180, MEC device 145 may initiate a new slice 331 to support a particular service or use case. As described further herein, in one implementation, MEC 145 may interact with NEF 270 and/or provisioning system 190 (not shown in FIG. 3) to establish new slice 331. In another implementation, MEC 145 may interact with an application being executed on a UE device 110 to invoke a new slice 331.

AI engine 180 may receive slice performance data from MEC devices 145 and application requirements/metrics from application function 305. AI engine 180 may monitor the capabilities and performance of individual slices 330 and determine if there is a need to create a new network slice. For example, based on a particular application/use case AI engine 180 may determine if a new slice would be beneficial and trigger an event to create new slice 331. In one implementation, AI engine 180 may use APIs 340 to trigger MEC device 145 to initiate a new slice 331.

According to an implementation, UE devices 110 may include a client application 350 that receives application services from application server 305. For a UE device 110 to enable client application 350 to establish a session via a network slice 330, UE device 110 may look up rules, herein referred to as UE Route Selection Policy (URSP) rules (also referred to as URSP) to select a route to a network slice 330. When application 350 requests UE device 110 (or more precisely, components within UE device 110 responsible for handling lower layers of telecommunication) to set up a connection to RAN 120 for client application 350, client application 350 may pass to UE device 110 only limited information, such as a traffic descriptor (e.g., a piece of information which indicates a type of traffic that application 350 may exchange with network slice 330). UE device 110 may then use the traffic descriptor to look up a URSP rule to identify the network slice 330 to which application 350 will establish a session. As described further herein, client application 350 may include an embedded slice-selection influencer. The embedded slice-selection influencer may be used to initiate infusion of a new slice into the network without updating the URSP based on, for example, trigger instructions from MEC device 145. In other implementations, MEC device 145 may provide instructions to initiate infusion of a new slice via the network using updated URSP rules for UE device 110.

FIG. 3 shows an example arrangement of components in network portion 300, in other implementations, fewer components, different components, differently arranged components, or additional components may be used. For example, while a MOCN deployment scenario for private networks is shown in FIG. 3, other deployment scenarios may include a stand-alone non-public network (SNPN), a public network integrated non-public network (PNI-NPN), a Multi-Operator Radio Access Network (MORAN), or private slice as part of public/macro network.

FIG. 4 illustrates example components of a device 400 according to an implementation described herein. UE device 110, access station 125, network device 135, MEC device 145, AI engine 180, provisioning system 190, AMF 240, UPF 245, SMF 250, UDM/UDR 255, PCF 260, AUSF 265, NEF 270, NWDAF 275, NSMF 280, NSSF 285, application server 305, and other devices in environment 100 may each include one or more devices 400. Device 400 may include a bus 410, a processor 420, a memory 430, an input component 440, an output component 450, and a communication interface 460.

Bus 410 may include a path that permits communication among the components of device 400. Processor 420 may include a processor, a microprocessor, or processing logic that may interpret and execute instructions. Memory 430 may include any type of dynamic storage device that may store information and instructions, for execution by processor 420, and/or any type of non-volatile storage device that may store information for use by processor 420. Input component 440 may include a mechanism that permits a user to input information to device 400, such as a keyboard, a keypad, a button, a switch, etc. Output component 450 may include a mechanism that outputs information to the user, such as a display, a speaker, one or more light emitting diodes (LEDs), etc.

Communication interface 460 may include a transceiver that enables device 400 to communicate with other devices and/or systems via wireless communications, wired communications, or a combination of wireless and wired communications. For example, communication interface 460 may include mechanisms for communicating with another device or system via a network. Communication interface 460 may include an antenna assembly for transmission and/or reception of RF signals. For example, communication interface 460 may include one or more antennas to transmit and/or receive RF signals over the air. In one implementation, for example, communication interface 460 may communicate with a network and/or devices connected to a network. Alternatively, or additionally, communication interface 460 may be a logical component that includes input and output ports, input and output systems, and/or other input and output components that facilitate the transmission of data to other devices.

Device 400 may perform certain operations in response to processor 420 executing software instructions contained in a computer-readable medium, such as memory 430. A computer-readable medium may be defined as a non-transitory memory device. A memory device may include space within a single physical memory device or spread across multiple physical memory devices. The software instructions may be read into memory 430 from another computer-readable medium or from another device. The software instructions contained in memory 430 may cause processor 420 to perform processes described herein. Alternatively, hardwired circuitry may be used in place of or in combination with software instructions to implement processes described herein. Thus, implementations described herein are not limited to any specific combination of hardware circuitry and software.

Although FIG. 4 shows exemplary components of device 400, in other implementations, device 400 may contain fewer components, additional components, different components, or differently arranged components than those depicted in FIG. 4. Additionally, or alternatively, one or more components of device 400 may perform one or more tasks described as being performed by one or more other components of device 400.

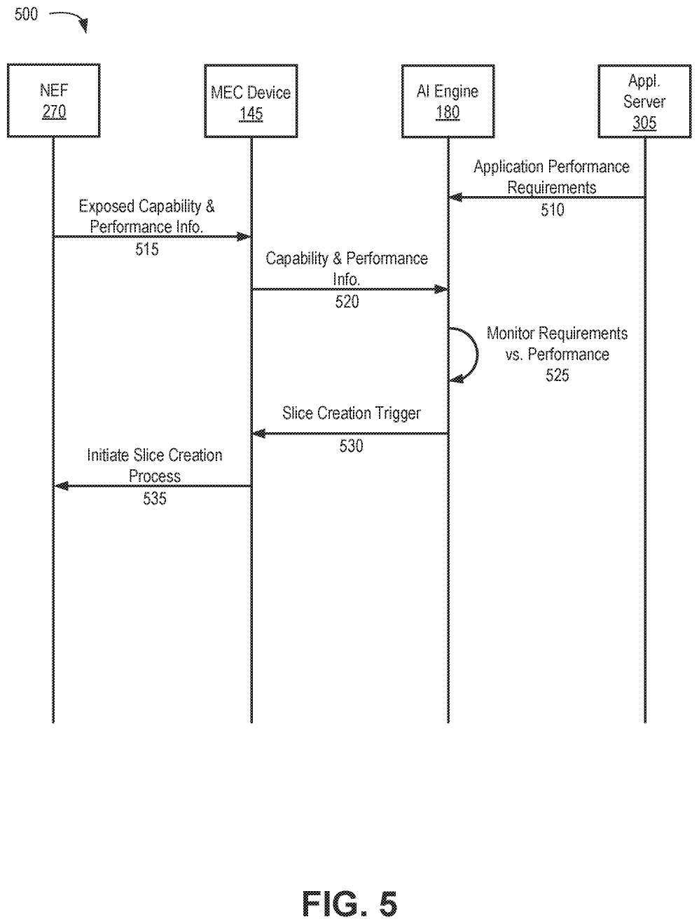

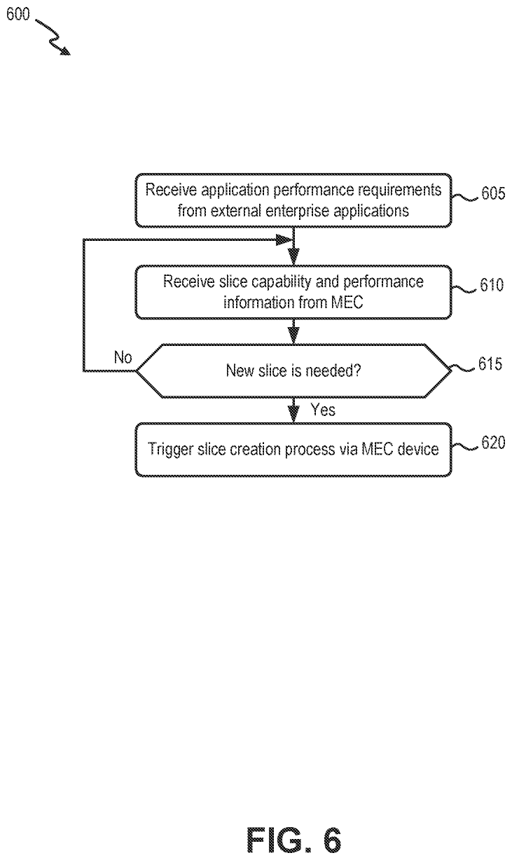

FIG. 5 is a signal flow diagram illustrating communications among devices in a portion 500 of network environment 300 to initiate dynamic slicing. Network portion 500 may include MEC device 145, AI engine 180, NEF 270, and application server 305. FIG. 6 is a flow diagram illustrating an example process 600 for initiating dynamic slicing, according to an implementation described herein. Process 600 is described below in the context of FIG. 5. In one implementation, process 600 may be implemented by AI engine 180. In another implementation, process 600 may be implemented by AI engine 180 in conjunction with one or more other network devices in network environment 300.

Process 600 may include receiving application performance requirements from external enterprise applications (block 605). For example, an enterprise application (e.g., application server 305) may use APIs 325 to communicate with AI engine 180. AI engine 180 may be separate from MEC device 145 or incorporated with MEC device 145. The enterprise application may provide a service request (e.g., latency, bandwidth, reliability, or other performance metrics) for the application. As shown in the example of FIG. 5, application server 305 may provide application performance requirements 510 to AI engine 180.

Process 600 may include receiving slice capability and performance information from a MEC device (block 610). For example, using APIs 335, NEF 270 in private core network 130-1 may expose to MEC device 145 performance and capability information of slices, such as 5QI, PER, latency, SPID/RFSP, PLMN, and ARP. MEC device 145 may receive the performance and capability information and, in turn, forward the information to AI engine 180 (e.g., via APIs 340). As shown in the example of FIG. 5, NEF 270 may provide exposed capability and performance information 515 to MEC device 145, and MEC device 145 may in turn provide the capability and performance information 520 to AI engine 180.

Process 600 may include determining if a new slice is needed (block 615). For example, based on the performance and capability information from private core network 130-1 and the service request from application server 305, AI engine 180 may identify a need to create a new slice (e.g., slice 331) with different characteristics than are currently available via existing network slices 330. As shown in the example of FIG. 5, AI engine 180 may monitor 525 the application performance requirements from application server 305 against the capability and performance information for the existing network slice to determine if the network slice is (or is not) meeting the application performance requirements.

If a new slice is not needed (block 615—No), process 600 may return to process block 610 to continue receiving slice capability and performance information from the MEC device 145. That is, if performance of the existing network slice is satisfactory, AI engine 180 will continue to monitor application performance requirements from application server 305 against periodically updated capability and performance information.

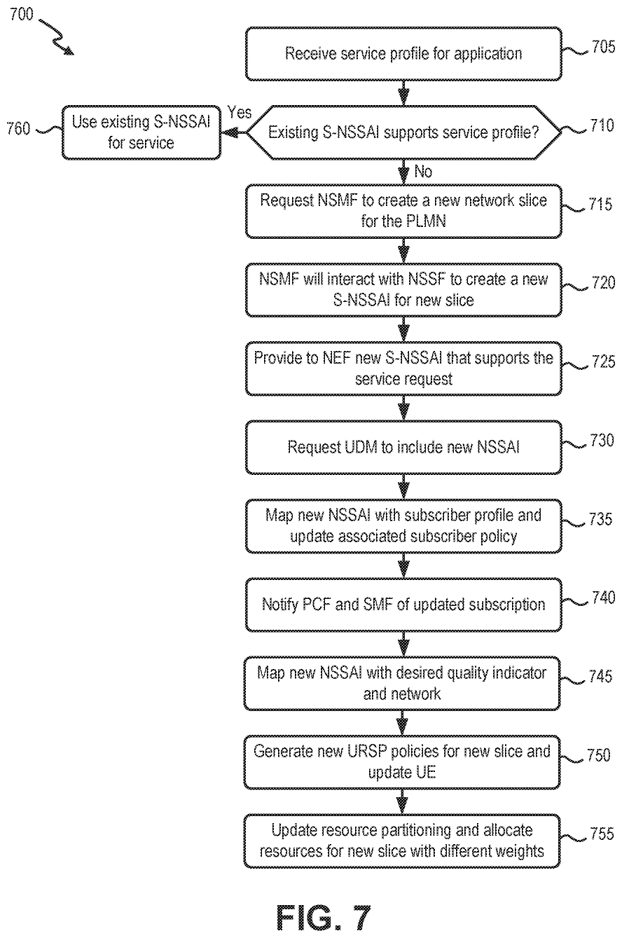

If a new slice is needed (block 615—Yes), process 600 may include triggering slice creation process via a MEC device (block 620). For example, AI engine 180 may use APIs 340 to initiate dynamic slice creation by MEC device 145. As shown in the example of FIG. 5, AI engine 180 may provide a slice creation trigger 530 to MEC device 145, which may in turn initiate slice creation process 535 with NEF 270. In one implementation, the dynamic slice creation may be implemented based on a network-controlled process, as described further in connection with FIG. 7. In another implementation, the dynamic slice creation may be implemented by the client application (e.g., client application 350) that is executed on the UE device 110, as described further in connection with FIG. 7.

FIG. 7 is a flow diagram illustrating an example process 700 for providing dynamic slice creation based on a network-controlled process, according to an implementation described herein. In one implementation, process 700 may be implemented by devices in a core network 130. In another implementation, process 700 may be implemented by devices in core network 130 in conjunction with one or more other network devices in network environment 100.

Process 700 may include receiving a service profile for an application (block 705) and determining if an existing S-NSSAI supports the service profile (block 710). For example, in response to an event trigger from AI engine 180, MEC device 145 may interact with NEF 270 and provisioning system 190 to define a differentiated service for a new network slice. In one implementation, NEF 270 may receive a service profile from MEC device 145 via APIs 335. NEF 270 may determine if an S-NSSAI for UE device 110 supports the service profile requested by MEC device 145.

If an existing S-NSSAI supports the service profile (block 710—Yes), process 700 may include using the existing S-NSSAI to service the application (block 760). For example, core network 130-1 may direct UE device 110 to switch to an existing network slice 330 that supports the service profile for the application.

If an existing S-NSSAI does not support the service profile (block 710—No), process 700 may include requesting an NSMF to create a new network slice for the PLMN (block 715), creating a new S-NSSAI for the new slice (block 720), and providing the new S-NSSAI to the NEF (block 725). For example, if NEF 270 does not find an S-NSSAI that supports the service profile requested by MEC device 145, NEF 270 may request NSMF 280 to create a new network slice for the PLMN (e.g., RAN 120 and private core network 130-1). NSMF 280 may interact with NSSF 285 to create a new S-NSSAI for the new slice. NSMF 280 may provide the NEF 270 with the newly created S-NSSAI that supports the service request.

Process 700 may further include requesting a UDM to include the new S-NSSAI as a new provisioning slice (block 730), mapping a new NSSAI with a subscriber profile and updating the subscriber policy (block 735), and notifying a PCF and SMF of the updated subscription (block 740). For example, NEF 270 may request that UDM/UDR 255 include the new NSSAI as a new provisioning slice along with a priority and a PLMN ID. UDM/UDR 255 (and a corresponding UDR) may map the new NSSAI with a subscriber profile and update an associated subscriber policy. The updated subscription information will be provided to SMF 250 and PCF 260.

Process 700 may additionally include mapping the new NSSAI with a desired quality indicator and network (block 745) and generating new URSP policies for the new slice (block 750). For example, SMF 250 may map the new NSSAI with the desired 5QI/QoS and Data Network Name (DNN). PCF 260 may generate new URSP policies for the new slice (e.g., the new NSSAI) and provide the updated URSP to UE device 110.

Process 700 may also include updating resource partitioning and allocating resources for the new slice with different weights (block 755). For example, RAN 120 may update the resource partitioning and allocate Data Radio Bearers (DRBs) and/or Physical Resource Block (PRBs) for the new slice with different weights. If the new slice is for prioritized services such as Public Safety, for example, the current slice traffic can be influenced to support the new slice that is supporting prioritized services. UE device 110 may use the new URSP rule and may initiate a new PDU establishment process for a DNN to the updated S-NSSAI, thus ensuring that client application 350 will be serviced by the new network slice.

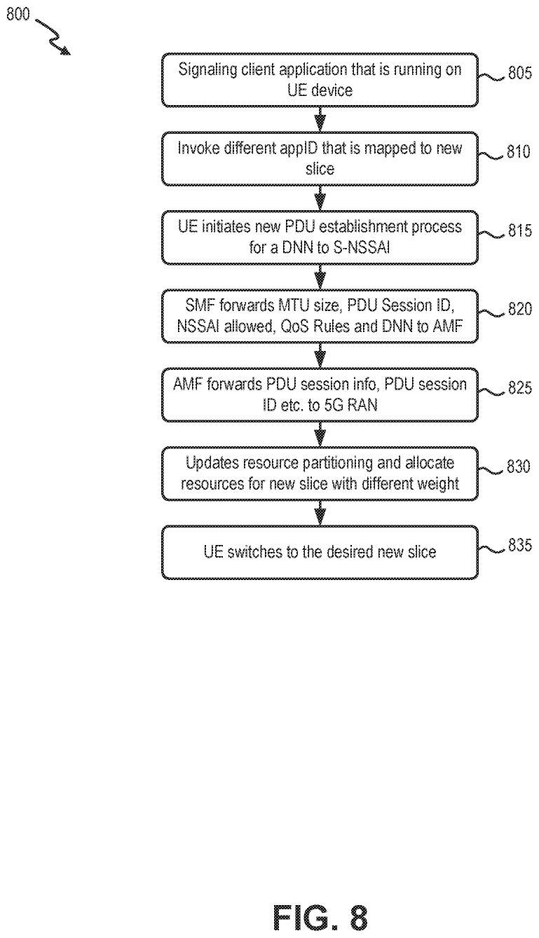

FIG. 8 is a flow diagram illustrating an example process 800 for providing dynamic slice creation based on an application-embedded slice-selection influencer, according to an implementation described herein. In one implementation, process 800 may be implemented by UE device 110 in conjunction with devices in a core network 130. In another implementation, process 800 may be implemented by UE device 110 in conjunction with one or more other network devices in network environment 100.

Process 800 may include signaling the client application that is running on the UE device (block 805) and invoking a different application identifier (appID) that is mapped to a new slice (block 810). For example, MEC device 145 may interact with client application 350 to initiate a slice change. MEC device 145 may indicate to client application 350 that the current network slice is underperforming for a particular appID (e.g., based on information from AI engine 180). In response, client application 350 may use an application-embedded slice-selection influencer to invoke a different appID (the appID of the client application 350 whose service requirements are not being met) that is mapped to a new slice. The appID may be mapped by UDM/UDR 255 with a URSP rule which has information on which DNN is to be used, an IP Address, NSSAI, etc., for a given PLMN. The PLMN may be, for example, private core network 130-1, macro core network 130-2, or a combination of the two.

Process 800 may further include initiating a new PDU establishment process for a DNN to S-NSSAI (block 815). For example, UE device 110 may use the new URSP rule and initiate a new PDU establishment process for a DNN to S-NSSAI.

Process 800 may also include an SMF forwarding Maximum Transmission Unit (MTU) size, PDU Session ID, NSSAI allowed, QoS Rules and DNN to an AMF (block 820) and the AMF forwarding the PUD session information to the RAN (block 825). For example, during a PDU re-establishment process based on requested DNN and requested N-SSAI by UE device 110, SMF 250 will select a MTU size and forward the MTU size along with a PDU Session ID, the allowed NSSAI, QOS Rules (e.g., obtain from PCF 260) and DNN to AMF 240. In turn, AMF 240 may forward the PDU session info, PDU session ID, etc., to RAN 120.

Process 800 may additionally include updating resource partitioning and allocating resources for the new slice with different weights (block 830) and switching to the desired new network slice (block 835). For example, RAN 120 may update the resource partitioning and allocate Data Radio Bearers (DRBs) and/or Physical Resource Block (PRBs) for the new slice with different weights. UE device 110 may receive the new values from RAN 120 and switch to the new network slice (e.g., slice 331). If the new slice is for prioritized services such as Public Safety, for example, the current slice traffic can be influenced to support the new slice that is supporting prioritized services.

The foregoing description of implementations provides illustration and description but is not intended to be exhaustive or to limit the invention to the precise form disclosed. Modifications and variations are possible in light of the above teachings or may be acquired from practice of the invention. For example, while a series of blocks have been described with regard to FIGS. 6-8, and message/operation flows with respect to FIG. 5, the order of the blocks and message/operation flows may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device and from an application server, application performance requirements for an application;
receiving, by the network device, capability and performance information of an existing network slice that is servicing a User Equipment (UE) device using the application;
determining, by the network device and based on the capability and performance information, that a new network slice is needed to support the application performance requirements for the UE device; and
sending, by the network device, a signal to initiate a slice creation process for the new network slice.

2. The method of claim 1, wherein the network device includes a network function co-located with a multi-access edge computing (MEC) device.

3. The method of claim 1, wherein the capability and performance information of the existing network slice is generated from a device within a core network, and wherein the network device includes a network function located outside the core network.

4. The method of claim 1, wherein the signal to initiate the slice creation process includes a service profile for the application.

5. The method of claim 4, further comprising:
forwarding, by a multi-access edge computing (MEC) device, the service profile to a Network Exposure Function (NEF) for a core network; and
creating, by a provisioning system and based on the service profile, the new network slice that is configured to support the service profile.

6. The method of claim 5, further comprising:
generating, by the core network, an updated UE Route Selection Policy (URSP) for the new network slice; and
forwarding the updated URSP to the UE device.

7. The method of claim 1, further comprising:
sending, by a multi-access edge computing (MEC) device and based on the signal to initiate a slice creation process, a signal to a client application on the UE device, wherein the client application includes an embedded slice-selection influencer.

8. The method of claim 7, further comprising:
receiving, at a core network and from the UE device, new session establishment request based on a second application identifier for the client application, wherein the second application identifier is different than a first application identifier used for the existing network slice.

9. The method of claim 1, further comprising:
generating, by the network device and based on the application performance requirements, a service profile for the new network slice, wherein the service profile includes a 5G Quality of Service Identifier (5QI).

10. The method of claim 1, wherein the new network slice is included in one or more of:
a stand-alone non-public network (SNPN),
a public network integrated non-public network (PNI-NPN),
a Multi-Operator Radio Access Network (MORAN), or
a multi-operator core network (MOCN).

11. A network device comprising:
a processor configured to:
receive, from an application server, application performance requirements for an application;
receive capability and performance information of an existing network slice that is servicing a User Equipment (UE) device using the application;
determine, based on the capability and performance information, that a new network slice is needed to support the application performance requirements for the UE device; and
send a signal to initiate a slice creation process for the new network slice.

12. The network device of claim 11, wherein the network device is co-located with a multi-access edge computing (MEC) device.

13. The network device of claim 11, wherein, when receiving the capability and performance information, the processor is further configured to:
receive the capability and performance information provided from a core network via a multi-access edge computing (MEC) device.

14. The network device of claim 11, wherein the signal to initiate the slice creation process includes a service profile for the application.

15. The network device of claim 11, wherein the processor is further configured to:
generate, based on the application performance requirements, a service profile for the new network slice, wherein the service profile includes a 5G Quality of Service Identifier (5QI).

16. The network device of claim 11, wherein the application performance requirements include one or more of:
a latency value, a throughput value, a reliability value, a packet error rate value, a bit rate value, or a maximum data burst volume.

17. A non-transitory computer-readable medium containing instructions, executable by at least one processor, for:
receiving, by a network device and from an application server, application performance requirements for an application;
receiving, by the network device, capability and performance information of an existing network slice that is servicing a User Equipment (UE) device using the application;
determining, by the network device and based on the capability and performance information, that a new network slice is needed to support the application performance requirements for the UE device; and
sending, by the network device, a signal to initiate a slice creation process for the new network slice.

18. The non-transitory computer-readable medium of claim 17, further comprising instructions for:
generating, by the network device and based on the application performance requirements, a service profile for the new network slice, wherein the service profile includes a 5G Quality of Service Identifier (5QI).

19. The non-transitory computer-readable medium of claim 17, wherein the application performance requirements include one or more of:
a latency value, a throughput value, a reliability value, a packet error rate value, a bit rate value, or a maximum data burst volume.

20. The non-transitory computer-readable medium of claim 17, wherein the signal to initiate the slice creation process includes a service profile for the application.
